(19) United States
(12) Patent Application Publication
(10) Pub. No.: US 2026/0080336 A1
(43) Pub. Date: Mar. 19, 2026

(54) REINFORCEMENT LEARNING APPROACH TO INSIDER THREAT DETECTION AND MITIGATION

(71) Applicant: Royal Bank of Canada, Toronto (CA)

(72) Inventors: Fatima HUSSAIN, Toronto (CA); Moussa NOUN, Toronto (CA); Jean-Pierre MALHERBE, Toronto (CA)

(21) Appl. No.: 19/327,319

(22) Filed: Sep. 12, 2025

(30) Foreign Application Priority Data
Sep. 13, 2024 (US) 63/694300

(51) Int. Cl. G06Q 10/0635

(52) U.S. Cl. CPC G06Q 10/0635

(57) ABSTRACT

Insider threats to a company can be detected and possibly mitigated by: receiving employee activity data comprising one or more activities or alerts each associated with a respective employee of a plurality of employees. The activities or alerts can be applied to a respective Markov model transition matrix to determine a next possible action of the employee. The one or more activities or alerts for the employee may also be applied to a reinforcement learning model to predict an employee risk that the employee may be an insider threat. Based on at least one of the determined next possible action and the predicted employee risk, threat mitigation controls, such as monitoring or controlling employee access to systems, can be adjusted.

### RELATED APPLICATIONS

The current application claims priority to U.S. Provisional Patent 63/694,300 entitled “Reinforcement Learning Approach To Insider Threat Detection and Mitigation”, filed Sep. 13, 2024, the entire contents of which are incorporated herein by reference.

### TECHNICAL FIELD

The current disclosure relates to the detection and mitigation of insider threats, and incorporating Markov and Reinforcement Learning techniques for the threat detection.

### BACKGROUND

Organizations face many security risks, including both external and internal threats. Organizations may use various techniques to mitigate the risks associated with these threats. Insider threats are threats caused by employees internal to the organization. These threats can range in risk and severity. For example, an employee resigning to move to a different organization may be considered a relatively low risk/severity. Other threats such as downloading and exfiltrating confidential business information may be a higher risk.

Organizations may monitor the actions of employees in an attempt to identify anomalous behavior, allowing mitigating steps to be taken in order to reduce the risk of the anomalous behavior. While such systems may be useful in detecting anomalous behavior, they may not detect all threats or may not detect the threats until they have occurred.

An additional, alternative and/or improved way to detect and mitigate possible insider threats is desirable.

### BRIEF DESCRIPTION OF THE DRAWINGS

Further features and advantages of the present disclosure will become apparent from the following detailed description, taken in combination with the appended drawings, in which:

FIG. 1 depicts a system for insider threat detection;

FIG. 2 depicts components for insider threat detection;

FIG. 3 depicts a method for insider threat detection;

FIG. 4 depicts a transition network graph between different states;

FIG. 5 depicts an employee's action states;

FIG. 6 depicts a method for determining a cumulative reward for reinforcement learning;

FIG. 7 depicts a timeline view for use in investigating an employee's actions; and

FIG. 8 depicts further display components for use in investigating an employee's actions.

### DETAILED DESCRIPTION

In accordance with the present disclosure there is provided a method for use in protecting against insider threats comprising: receiving employee activity data comprising one or more activities or alerts each associated with a respective employee of a plurality of employees; applying the one or more activities or alerts for an employee to a respective Markov model transition matrix to determine a next possible action of the employee; applying the one or more activities or alerts for the employee to a reinforcement learning model to predict an employee risk that the employee may be an insider threat; and adjusting threat mitigation controls comprising one or more of employee monitoring controls and employee access control based on at least one of the determined next possible action and the predicted employee risk.

In a further embodiment of the method, the employee activity data is received in a batch at an interval of at least one of: one hour; six hours; twelve hours; and one day.

In a further embodiment of the method, the employee activity data is received in real-time or near real-time.

In a further embodiment of the method, the activities or alerts are each associated with one of a plurality of pre-defined domains.

In a further embodiment of the method, adjusting the threat mitigation controls comprises monitoring an employee when the determined next state is a state associated with an insider threat.

In a further embodiment of the method, the method further comprises receiving historical employee data and generating the respective Markov model for each employee based on the historical data.

In a further embodiment of the method, the reinforcement learning model receives one or more employee attributes in addition to the one or more activities or alerts.

In a further embodiment of the method, the method further comprises receiving historical employee data and training the reinforcement learning model.

In a further embodiment of the method, the reinforcement learning model uses agents running Q-learning algorithms.

In a further embodiment of the method, each agent performs feature selection in each of a plurality of domains to maximize a risk.

In a further embodiment of the method, directed exploration technique is used in the reinforcement learning.

In a further embodiment of the method, softmax exploration techniques are used in the reinforcement learning.

In a further embodiment of the method, the method further comprises: receiving an indication of a particular employee; receiving an indication of a specific time window; and displaying employee risk information for the particular employee over the specific time window.

In accordance with the present disclosure there is further provided a system for use in detecting insider threats comprising: a processor for executing instructions; and a memory storing instructions, which when executed configure the system to perform a method according to any of the methods described above.

In accordance with the present disclosure there is further provided a non-transitory computer readable medium storing instructions which when executed by a processor configure a system to perform a method according to any of the methods described above.

Multimodal internal threat detection attempts to anticipate the possible future behavior of an employee, and based on the possible future behaviors to take corresponding precautions and actions to mitigate potential threats as well as support further investigations. The insider threat detection described herein helps to perform analysis of employee behavior and can help with in-depth investigation by providing visualization and storytelling with valuable insights for understanding the employee's behavior.

Existing security controls can provide judgement on anomalous behavior based on an anomaly score calculated based on their behavior. As a simple example, an employee who never downloads documents from a particular server may have a large anomaly score if they suddenly download large amounts of data from the server. User Behavior Analytics (UBA) can contextualize these abnormalities and provide the probability of maliciousness of an employee, which can identify if the employee should be the subject of investigations. These behavior analytics controls are reactive in nature as investigation starts when some abnormality occurs. The insider threat detection described herein is a proactive control and can identify potentially malicious users on previous history and predict their next action. Multiple action buckets can be created and users are grouped into these buckets based on predicted actions. Afterwards, buckets with high risk states can be further monitored. Further, the events for employees within the high risk buckets can be investigated further or monitored more closely, but also allows mitigation actions to be proactively taken mitigate the risk. For example, a high risk employee may result in strengthening the security controls around that employee for a specific domain. The insider threat detection described further herein improves the detection and remediation processes for insider threat mitigation.

The internal threat detection predicts the future activity of an employee based on historical activities and contextual information around those activities. The threat detection is multimodal and uses a Markov model to predict an employee's next action based on their previous action and a reinforcement learning (RL) model trained on historical data and employee attributes. The RL model can be used to predict an employee's next action and also predict that the user's actions will lead to a threat in the future.

The internal threat detection provides valuable insights for understanding employee activity patterns, serving as early warning signs, effectively predicting and mitigating the potential insider threats such as data leakage, and suggesting the areas where additional training or reinforcement is needed, thereby upholding the integrity and security of sensitive data. Courses of action, or action chains, of employees are ranked on their likeliness to lead to malicious outcomes and broken up into individual actions. The current internal threat detection focuses on the probabilities of movement between each action and the overall risk associated with the course of action. These measurements allow a window into the employee's intentions and provides an opportunity to interrupt a malicious insider before the employee can complete their attack.

Data is collected from various data sources and can be contextualized and visualized over various time periods with a sliding window. The data can be processed in order to breakdown an employee's activity into various domains and feature selection in each domain for risk identification. A Markov model state transition diagram can be developed to capture an entire activity path for an employee's actions and identify risk in each activity and predict the next action of the employee. The internal threat detection described further herein formulates the insider threat detection as an optimization problem in order to identify employees posing maximum risk to an employer. In addition to the Markov mode, a reinforcement learning model is developed that incorporates historical behavior of an employee along with the current activity. The reinforcement learning model does not require dedicated training data and instead it learns from the actions of the employees and predict the future actions. A visualization dashboard can be used to visualize employee actions in a time series manner. The internal threat detection described further herein incorporates the internal threat detection and mitigation into a system that provides increased efficiency, accuracy, and automation for insider threat detection and mitigation to save employers from potential data leakage and bad market reputation or other threats. The internal threat detection and mitigation helps to reduce the time, resources and cost of investigation and remediation in potential security breach and incident situations.

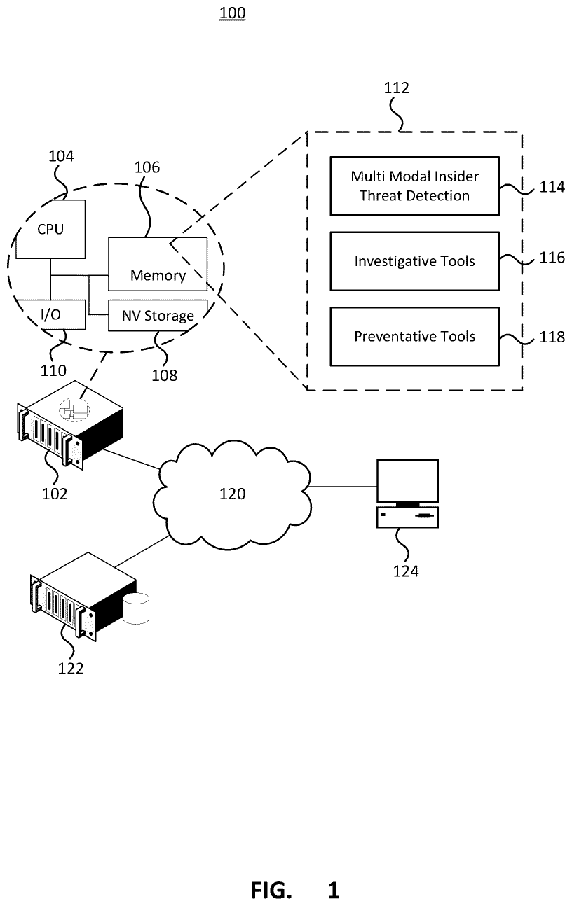

FIG. 1 depicts a system for insider threat detection. The system may include one or more computing devices 102. The computing devices 102 may contain one or more processors or microprocessors, such as a central processing unit (CPU) 104. The CPU performs arithmetic calculations and control functions to execute software stored in a non-transitory internal memory 106, preferably random access memory (RAM) and/or read only memory (ROM), and possibly additional memory 108. The additional memory is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory may be physically internal to the computer system, or both.

The one or more processors or microprocessors may comprise any suitable processing unit such as an artificial intelligence accelerator, programmable logic controller, a microcontroller (which comprises both a processing unit and a non-transitory computer readable medium), μl accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system may also include other similar means for allowing computer programs or other instructions to be loaded. Such means can include, for example, a communications interface (not shown) which allows software and data to be transferred between the computer system and external systems and networks. Examples of communication interfaces can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by the communications interface. Multiple interfaces, of course, can be provided on a single computer system.

Input and output to and from the computer system may be administered by the input/output (I/O) interface 110. The I/O interface may administer control of the display, keyboard, external devices and other such components of the computer system. The computer system may also include a graphical processing unit (GPU). The GPU may also be used for computational purposes as an adjunct to, or instead of, the (CPU), for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory may store instructions which when executed by the processor, and possibly the GPU, configure the system to provide various functionality 112. The functionality 112 may include multimodal insider threat detection functionality 114 which uses both a Markov model and a RL model to predict an employee's next action and the employee's threat risk. The information provided about employee from the multi modal insider threat detection functionality 114 can be used by various other downstream functionality that provides investigative tools 116 which can be used by an investigator during monitoring and/or investigating employees and their behaviors. Additionally, the information from the multimodal insider threat detection functionality may be used by one or more preventative tools used to, for example, provide further monitoring of employees, as well as adjusting access or security controls of the employee.

The functionality 110 is depicted as being provided by a single computing system 102, however, it will be appreciated that the functionality may be provided across one or more computing systems that are communicatively coupled with each other, either directly or indirectly. The system 100 may include one or more communication networks 120 coupling additional computing devices 122, 124 together. The additional computing devices 122 may include computing devices such as servers 122 as well as one or more personal computers 124 that provide various functionality to the employer. The additional computing devices 122, 124 may include additional computing devices not depicted in FIG. 1, such as laptop computers, mobile phones, tablets, etc. The additional computing devices 122, 124 may be computing devices on an internal network or may be accessible through one or more external networks.

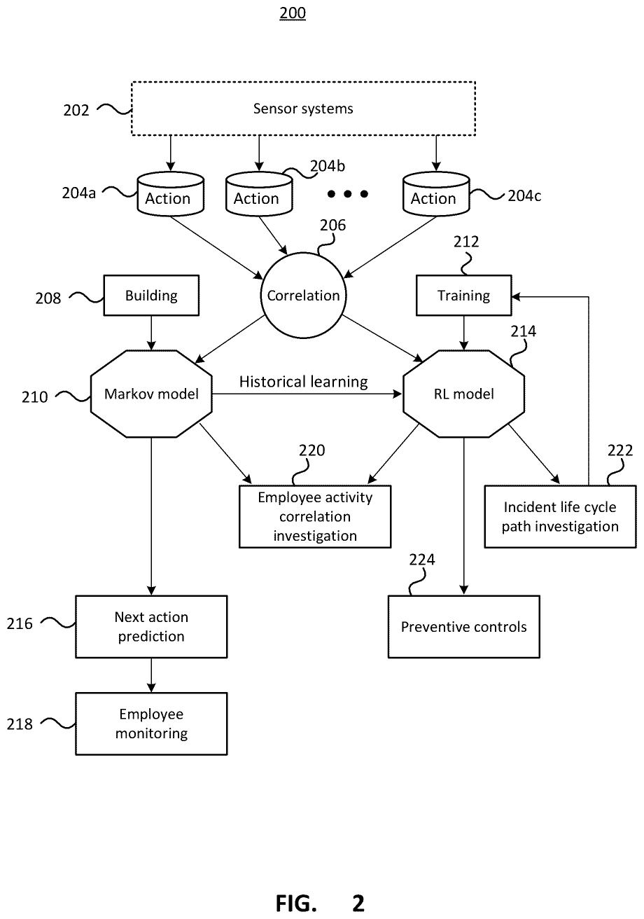

FIG. 2 depicts components for insider threat detection. The components 200 may be used to provide the multimodal insider threat detection and mitigation functionality described above. One or more sensor systems 202 provide data on a plurality of different actions 204a, 204b, 204c. The sensor systems may be provided by various functionality and may be associated with different domains within a company. For example, one sensor system may be a network sensor that reports network information about employees, such as an amount of data uploaded/downloaded from locations, such as specific networks, websites, etc. A different sensor system may be a physical access control system that can provide information such as times and locations that an employee has entered controlled locations. Other sensor systems may include data access information that provides information about when employees have accessed network resources. Other sensor systems may provide actions or alerts by processing other data. For example data loss prevention (DLP) functionality may provide various alerts that an employee has accessed or attempted to access sensitive information that they should not be accessing. Similarly, user behavioral analysis (UBA) can provide alerts when an employee's behavior or actions are considered anomalous. The system sensors can provide direct actions of users or may provide actions or alerts generated by processing other information about the user.

The actions 204a, 204b, 204c are depicted as being arranged into various domains or groups. The domains may be based on the system associated with the actions or alters. For example, one domain may be generated from user behavior analysis systems, another domain may be generated from printer information indicating what the employee has printed, another domain may comprise network information, and another domain may be generated from a security system that provides alerts of actual incidents associated with an employee. It will be appreciated that the particular actions/alerts provided by the sensor systems 202 can vary and the information may be arranged across different domains than that described above.

The actions/alerts 202a . . . 202c can be correlated together 206. The correlation may involve associated a time, or time range, with an action or alert. The correlation 206 allows the actions to be viewed as a sequence of events. The action data may be initially ingested based on historical data, which can be used by building functionality 208 in order to build a Markov model 210. The historical data, along with possibly employee attributes, may also be used by training functionality 212 in order to train a reinforcement learning (RL) model 214. The RL model may use information from the Markov model for the historical learning about employee actions.

Once the Markov model is built and the RL model initially trained, the data may be received, correlated and processed either periodically, or in real-time or near real-time. For example, the data from the various sensor systems may be processed every hour, few hours, day, week, etc. It will be appreciated that processing the data more frequently may provide a faster detection or response to potential threats, however may require more computational resources.

The Markov model 210 is used to predict a next action 216 that is likely to be taken by the user based on their previous actions. The Markov model may be used to predict multiple future actions, or chains of actions, by repeatedly applying the next predicted action to the Markov model. Based on the next prediction action state predicted by the Markov model, an employee may be deemed to be high risk. For example, if the next action state is predicted to be associated with an incident or threat, the employee may be considered as high risk and further employee monitoring 218 may be applied to the employee. The monitoring may involve various measures, including for example having a security personnel review the employee's actions in a real-time or near real-time manner, or at least at a more frequent interval. Further actions may also be taken such as limiting the employee's access to information or services. Additionally, the next predicted action or actions may be used by investigation functionality 220 that allows the employee actions to be visually correlated and displayed in a manner that allows investigators to more quickly determine if further actions or monitoring should be applied to the employee. The investigation functionality 220 may also incorporate information from the RL model in the information presented to investigators.

The RL model also processes new actions from employees and can determine next actions of the employee similar to the Markov model. However, where the Markov model may predict an action based on a previous action, the RL model can predict next actions based on all of the previous actions, or a subset of the previous actions. The RL model can predict which chain of actions lead to a risk related incident and whether the current employee's actions place them on the chain of events. Lifecycle incident path investigation functionality 222 can be used to help investigators determine likely paths that the employee is on, and whether any of them lead to an incident state. Preventative controls 224 can be used in order to restrict further actions of the employee. For example, if it is determined that the user is on an action path that could lead to a security incident, further restrictions that make the subsequent actions required for the incident more difficult can be put in place. For example, if the incident is exfiltrating sensitive information, and the employee's last action was to download a large amount of information, further employee restrictions can be implemented that would make exfiltration of the data difficult, such as restricting the employee's ability to print, upload data, monitoring email attachments, etc.

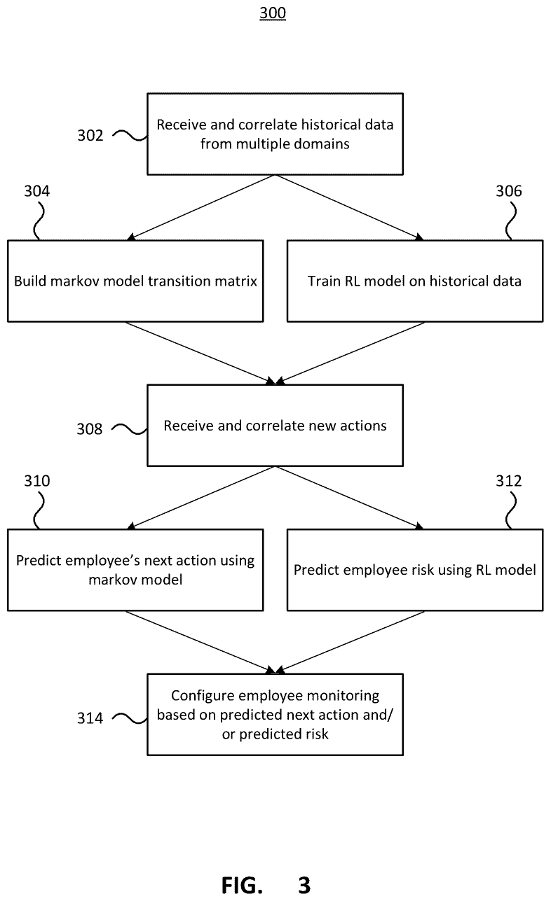

FIG. 3 depicts a method for insider threat detection. The method 300 begins with receiving historical and current employee data and correlating it (302) as a time series of events or actions. The employee data may comprise a plurality of actions, or states, grouped across a plurality of domains. The correlated historical data can be processed in order to build a transition matrix (304) for individual employees, or groups of employees, showing the probability of moving from one action state to another. The correlated historical data, along with employee attributes is also used to initially train the RL model (306). Once the Markov model and RL model are trained based on historical data, the models may be used. During use, new action data is periodically received and correlated together (308). The correlated data can be applied to the Markov model to predict a next action of the employee (310) associated with the Markov model. Additionally, the new actions can be applied to the RL model to predict further actions and predict a risk that the user's actions will lead to a security incident (312). Based on the predictions, employee monitoring can be configured and deployed (314), which may include for example applying more stringent monitoring of the employee's behavior, as well as placing restrictions or alerts on the employee's actions.

Employees perform actions in their daily office operations and each action exhibits some prominent feature or features associated with it. The goal of the insider threat detection is to identify the employee's actions performed with malicious intent, which may pose a potential threat to the organization. The insider threat detection uses Markov model and Reinforcement Learning for this purpose. The different states, or actions, to be traversed by an agent corresponding to an employee are defined. The combination of features associated with each action is considered as states, and each of the state is traversed for the search of potential high risk states, which similarly correspond to employee actions. Reward accumulation is done at each traversed state, and a cumulative reward is obtained at the end. With the cumulative risk rewards determined, all the employees can be arranged according to high risk actions.

The overall process for the insider threat detection begins with defining the states, which may be independent states, based on the historical employee actions/alerts. The definition of the states may be done manually for example by reviewing the historical data and determining which actions have led to undesirable outcomes or states. With the states defined, the probability of an employee moving from one state to another can be determined from the historical data, which may also capture the switching between states as well as the time difference between the two states for each employee. The probability of landing on a next state out of all possible states, or actions, can be determined. The next states may be particularly focused on threat states such as those associated with DLP alerts and real incident reports for each employee. The RL model can be used to predict the most probable action among all the actions in various time windows, which may allow investigations using a sliding window. The results may be presented on a dashboard that allows an investigator or other user to analyze the time axis historical view of an employee actions as a sequence of events moving from one state to another.

The Markov model transition matrix is used to account for the sequential relationship between actions and to help to predict the next action of each employee. The Markov Chain Model shows the next state value through an arbitrary variable affected by the previous event. Similarly, the current activity can also be predicted based on the previous activity for the specific employee'activity. A transition matrix is developed for each employee, or group of similar employees, to capture the probability of change of state from one to another, for all the available states. There are number of possible paths present between two corresponding states, however, only the significant paths or patterns important for prediction are obtained from the data set. These states may be identified manually or automatically using a trained model.

The RL model includes the benefits of Markov model along with the learning done by the RL model from historical behavior. This is useful in scenarios that involve sequential decision-making beyond simple prediction on a static record. The RL model does not require a dedicated training data set and learning is obtained via the direct interaction of agents with the environment.

In the RL model, all the state paths followed by an employee are analyzed along with consideration of related employee' attributes. The RL model will learn the typical state path followed by employees' that result in a possibly security threat state or otherwise undesirable state. The employees on that specific malicious path, or similar paths, are identified. With a high number of states/actions for employees, it can be very complex for simple RL approach to learn from all states and determine the reward/policy path. In such scenarios, deep reinforcement learning can be used with a neural network to estimate the states instead of having to map every solution, creating a more manageable solution space in the decision process.

While the states, or actions, and their groupings into domains can differ. One example is shown in Table 1 below.

TABLE 1

| Domains | Description | Features or Activity |
|---|---|---|
| Netskope | Netskope Activity | Download, Upload |
| SCUBA | off-policy | numerous emails |
| Print | Print Anomaly | print count, |
| | | weekend prints |
| DLP Alerts | Policy Violation | Policy 1, Policy 2 |
| Leave | Submitted the | Feature 1, |
| | resignation | Feature 2 |
| Real Incidents | Real incidents happened | severity, number of |
| | before or to happen | incidents |

Consider K=[k1, k2, k3, . . . , kK] employees having access to various systems in an enterprise. Based on context of actions, the employee actions and behaviors can be divided into D domains, for example as shown in Table 1 above, with F features. Let be the risk associated with each feature or action taken by the employee. The total risk associated with an employee for possible insider threat is defined as R, which is a function of r for each action taken by the employee.

$$Where , R = [ f ( {r}^{f 1} , {r}^{f 2} , {r}^{f 3} , … , {r}^{fF} ) ] \qquad ( 1 )$$

Let the k^{th} employee perform some action at time T that exhibits some features from d^{th} domain, and r is the risk associated with it. The total risk associated with that employee in all the domains at all the times is given as

$${R}_{D * T}^{k}$$

For the internal threat detection, it is desired to maximize the risk associated with each employee; such that further investigation is started for employees having maximum risk, or a risk above a certain threshold. The problem can be formulated as a maximization of risk associated with employee k in all the domains D, for all the features F, for all the time windows T in consideration:

$$Maximize {R}_{D} , ∀ D = [ d 1 , d 2 , … , dn ] \qquad ( 2 )$$

$$Such that \vert {R}_{D} \vert = ∀ D {\sum }_{t = 1}^{T} {r}_{t}^{F} , ∀ r = [ {r}_{f 1} , {r}_{f 2} , {r}_{f 3} , … , {r}_{fn} ] \qquad ( 3 )$$

$$Where F = [ ( {f}_{1}^{d 1} , … , {f}_{F}^{d 1} ) , ( {f}_{1}^{d 2} , … , {f}_{F}^{d 2} ) , … , ( {f}_{1}^{dn} , … , {f}_{F}^{dn} ) \qquad ( 4 )$$

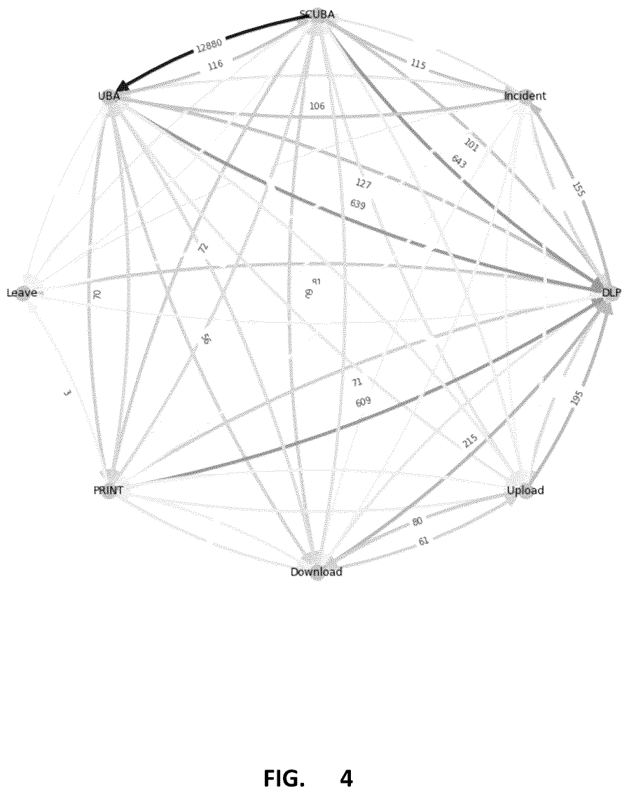

When building the transition matrix for the Markov model, the states are defined and the probability of switching between them determined as described above. A transition network graph is depicted in FIG. 4. It shows the connections and transitions, where the edge labeled by 1 means it's valid based on the transition rule, 0 otherwise. The darker color means a higher number of transitions between the states found in the dataset.

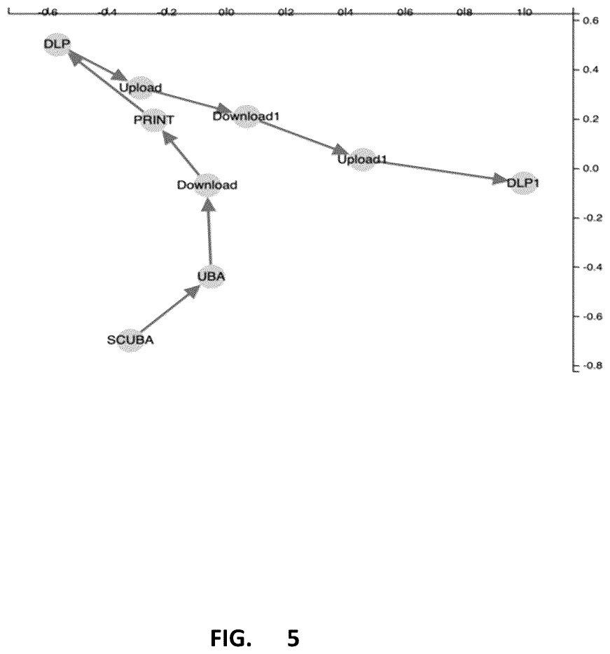

The different actions of an employee are associated with domains. There are various possible actions associated with different domains. Each action or activity of an employee corresponds to an individual state, and multiple paths are present between any two states. One such chain of states is depicted in FIG. 5. The insider threat detection focuses on significant states such as those that are known from the historical data to be associated with security threats. There are various applications of the insider threat detection. One such application is to identify those employees with the most risky next states, such as “Incident” and “DLP Alerts,” and employ enhanced monitoring and/or access controls for the employees falling into these buckets to proactively control the incident. A further application is to observe all the states and implement security controls on every type of action/alert, according to the potential risk.

As described above, the Markov model and transition matrix are used to perform next action prediction of an employee who may be identified or detected, such as by an existing monitoring control. There are chances that any employee, considering all their actions, or a specific action by an employee goes undetected as being a potential security threat. The RL model provides a further mechanism that considers all the actions/activities of an employee and scrutinizes them for risk identification, whether as an individual action or correlated with other actions. The RL model is a constant learning process and so evolves with time, which may be particularly useful to identify risks with changing behaviors. An RL model is initially trained from historical data. The model may consider all the employee attributes, and all action paths followed by employees can be analyzed. The RL model will learn from the typical path followed by potential offenders leading to a potential security threat and identify employees on that specific path or on any intermediate states, which may be identified as most risky. Further monitoring and/or access controls can be applied to the high-risk employees.

As an example, Table 2 below shows various paths followed by employees with a close focus on the final state, such as a real incident or policy violation (DLP alerts), identified as a malicious insider. Furthermore, other employees with most recent paths of Download, DLP, etc., are monitored for potential incidents.

TABLE 2

| | Path | | End |
|---|---|---|---|
| Action state path | length | Count | state |
| DLP, SCUBA, UBA, DLP, DLP, Leave, | 7 | 1 | Incident |
| Incident | | | |
| SCUBA, UBE, DLP, DLP, Leave, Incident | 6 | 1 | Incident |
| Upload, Download, DLP, SCUBA, UBA, | 6 | 1 | DLP |
| DLP | | | |
| DLP, SCUBA, UBA, DLP, DLP, Leave | 6 | 1 | Leave |
| Download, Incident, DLP, SCUBA, UBA, | 6 | 1 | Incident |
| Incident | | | |
| DLP, SCUA, UBA, DLP | 4 | 2 | DLP |
| Download, Incident, DLP, SCUBA | 4 | 1 | SCUBA |

For the RL model, an agent will move across all the domain states, following the most malicious path as identified by the historical path or paths of a malicious insider, in a sequential manner. Each domain will contribute to the maximum risk score of 1. The agent in each domain will hop into various states, with all the features within the domain will contribute as states and learn the reward for each state contributing to the specific domain reward. Once reward is obtained for one domain, the agent will move to the next domain and obtain the reward. A cumulative reward is obtained for all the domains as a sum of the individual domain rewards.

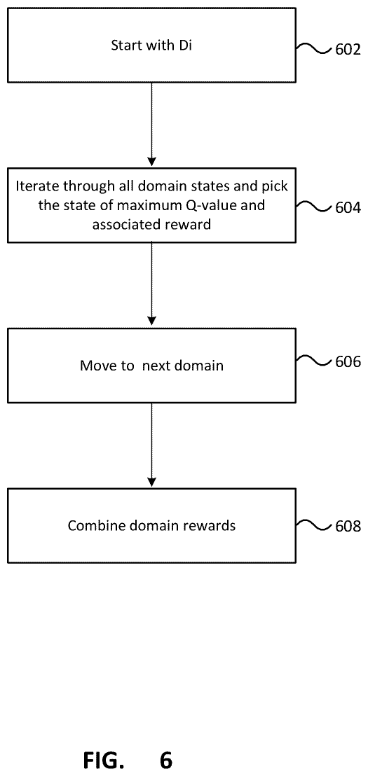

This process is depicted in FIG. 6. As depicted, the reward determination begins with the agent in a first domain Di (602). The agent iterates through all the domain states and picks the maximum Q-value and associated reward (604). The agent moves to the next domain (606) and again determines the maximum Q-value and associated reward for the new domain. Once the individual rewards are determined for the individual domains, the cumulative reward can be determined by combining the individual domain rewards together (608). The cumulative reward can be given by R_{D}=R_{d1}+R_{d2}+R_{d3}+ . . . . R_{dn}.

For the state description, a matrix M_{T} can be defined for all the employee agent, where the columns represent the possible domains and rows represent each feature associated with the action performed by each employee (agent).

The matrix with respective feature inclusion My is shown below:

$${M}_{T}^{i} = [ \begin{matrix}{D}_{1} & {D}_{2} & {D}_{3} & ⋯ & {D}_{N} \\ {f}_{1} & {f}_{1} & {f}_{1} & ⋯ & {f}_{1} \\ {f}_{2} & {f}_{2} & {f}_{2} & ⋯ & {f}_{2} \\ {f}_{3} & {f}_{3} & {f}_{3} & ⋯ & {f}_{3} \\ ⋯ & ⋯ & ⋯ & ⋯ & ⋯ \\ {f}_{F} & {f}_{F} & {f}_{F} & ⋯ & {f}_{F}\end{matrix} ] \qquad ( 5 )$$

where, Mᵢ=[k1, . . . , kK] and the matrix is calculated for each employee agent, for time period T. Afterwards, risk associated with each employee is calculated and is given in the form of matrix of risk and features contributing to it. However, for certain time t ET, each agent constitutes one state at a time and matrix M_{T} is reduced to matrix Mₜ.

$${M}_{t} = [ \begin{matrix}{k}_{1} & {k}_{2} & {k}_{3} & ⋯ & {k}_{K} \\ {f}_{1} & {f}_{1} & {f}_{1} & ⋯ & {f}_{1} \\ {f}_{2} & {f}_{2} & {f}_{2} & ⋯ & {f}_{2} \\ {f}_{3} & {f}_{3} & {f}_{3} & ⋯ & {f}_{3} \\ ⋯ & ⋯ & ⋯ & ⋯ & ⋯ \\ {f}_{F} & {f}_{F} & {f}_{F} & ⋯ & {f}_{F}\end{matrix} ] \qquad ( 6 )$$

Where each column represents each agent (employee), and each row represents the feature exhibited by agent during specific event happening at time t.

Risk matrix is obtained at the end of the Q-leaning algorithm convergence and agents are sorted with sequence of highest reward; employees with highest risk is at the top and with lowest risk at the bottom, as shown below:

$$R = [ \begin{matrix}{k}_{1} & {r}_{1} \\ {k}_{2} & {r}_{2} \\ {k}_{1} & {r}_{3} \\ ⋯ & ⋯ \\ {k}_{K} & {r}_{K}\end{matrix} ] \qquad ( 7 )$$

To this end, the reward is calculated when actions are performed by the agents (employees), followed by the Q value update, as follows:

Agent: Employee k, ∇1≤k≤K are the agents running Q-learning algorithm. These agents perform the selection of the states (features block) in each domain, and across the domain to maximize the risk.

Action: A(t)=a^{k,\hat{f}}^{_{bl}}(t), f_{bl} ∈[f_{bl}_{¹}, . . . , f_{bl}_{^{D}}], where a^{k,f}(t) is defined as the action of k^{th} employee at time instance t, in domain d and the aim is to choose a set of features in a specific domain

$${\hat{d}}_{n}^{f}$$

out of

$${d}_{n}^{f} ,$$

where

$$\vert {d}_{n}^{f} \vert = ( {2}^{F} )$$

is the number of states available to each employee in each domain, over the time interval T, while (D*2^{F}) is the total number of states. If action of an agent is confined to some time t∈T, each agent constitutes one state at a time as shown by matrix Mₜ.

Exploration strategy: Since historical data is available for employees, available paths for potential malicious insiders are known, and it is possible to adopt directed exploration techniques combined with a Softmax Exploration technique. The agents will pick those states that lead to the maximization of reward, i.e., maximum risk.

If the historical behavior and actions of employees were not available, conventional undirected exploration techniques could be used with the combination of the naive algorithm and the greedy algorithm. Agents start with a random selection (naive algorithm) of one state from a set of available states and afterwards select a state on the basis of Q-learning preferences (greedy algorithm). It will pick the state with the highest Q-value. If the reward of the current step is less than the action in the previous step, it will follow the naive strategy and sequentially pick the next state in the available states. This way, no state is left unattended, and all the states are traversed, and potential reward is calculated.

The reward is defined as the benefit an agent (employee) will get in terms of increased risk after exploring various states. The reward is assigned to be 1, if risk in the current state is greater than the risk in the previous state and 0 otherwise:

$${R}_{d} = \{ \begin{matrix}1 , & R \geq {R}^{t - 1} , \\ 0 , & R < {R}^{t - 1} ,\end{matrix} \qquad ( 8 )$$

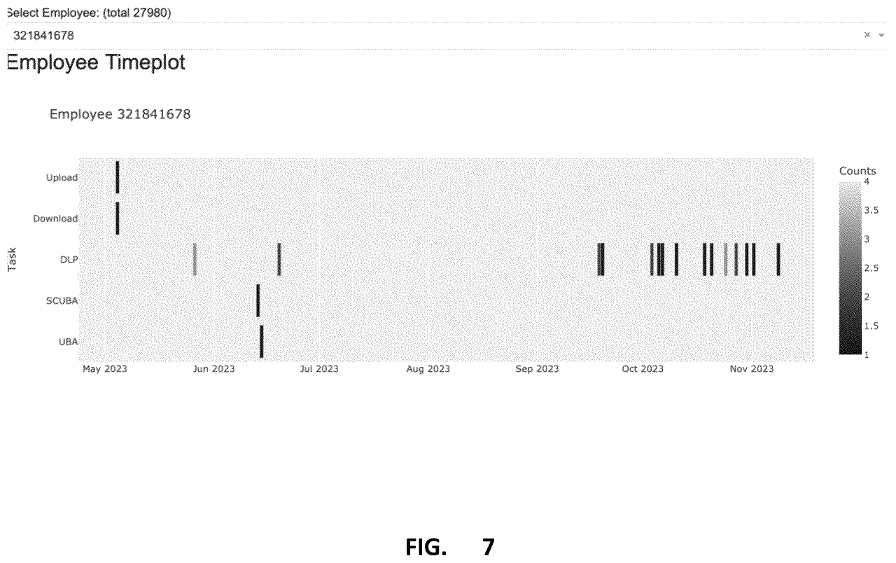

The Markov model and the RL model can be used to predict the risk of certain actions leading to a potential security threat. The information from these models, along with the employee action data, can be processed for display to investigators. For each employee, a timeline of actions can be plotted. A drop down box or other interface can be used to specify a particular employee to evaluate as shown in FIG. 7. All the actions of an employee are monitored and plotted on a time axis. This time axis view does not only depict the visual story of all the actions of an employee but also helps to build the context around each action and signifies hidden correlation among them.

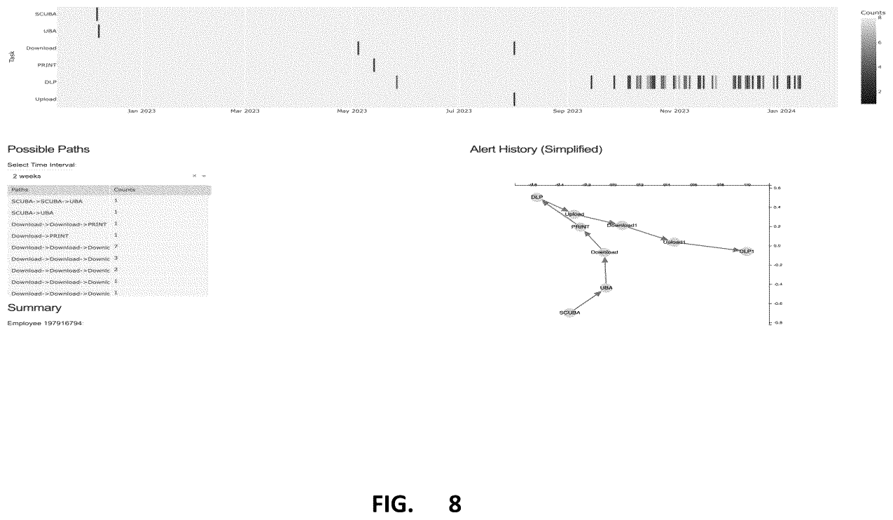

Employee activity, state transition and related graphs may be updated everyday and available for visualization on an employee activity dashboard. A specific employee may be selected along with particular behaviors and time windows, and a graph can be generated depicting the actions for the time window. An example dashboard is depicted in FIG. 8, which depicts a timeline plot similar to that of FIG. 7, along with a section allowing a selection of the sliding window time frame, such as 2, 3, 4, 8 weeks, etc., and corresponding valid activity patterns or paths present in the employee's actions over the selected time window and the frequency of the paths. The dashboard in FIG. 8 also depicts the employee's alert and incident history showing previous alerts and incidents for the employee. Other insights for the specific employee may also be generated and displayed.

It will be appreciated by one of ordinary skill in the art that the system and components shown in FIGS. 1-8 may include components and/or steps not shown in the drawings. For simplicity and clarity of the illustration, elements in the figures are not necessarily to scale, are only schematic, and are non-limiting of the elements and structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps, or the steps may be performed sequentially, non-sequentially, or concurrently. One or more features, components, and/or elements may be described with reference to a particular embodiment. Such features, components, and/or elements can be incorporated into and/or combined with other embodiments. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware, and/or hardware, other than the specific implementations described herein as illustrative examples.

The techniques of various embodiments may be implemented using software, hardware, and/or a combination of software and hardware. Various embodiments are directed to apparatus, e.g., a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more, or all the steps of the described method or methods.

Numerous additional variations on the methods and apparatus of the various embodiments described above will be apparent to those skilled in the art in view of the above description. Such variations are to be considered within the scope of the current disclosure.

What is claimed is:

1. A method for use in protecting against insider threats comprising:
receiving employee activity data comprising one or more activities or alerts each associated with a respective employee of a plurality of employees;
applying the one or more activities or alerts for an employee to a respective Markov model transition matrix to determine a next possible action of the employee;
applying the one or more activities or alerts for the employee to a reinforcement learning model to predict an employee risk that the employee may be an insider threat; and
adjusting threat mitigation controls comprising one or more of employee monitoring controls and employee access control based on at least one of the determined next possible action and the predicted employee risk.

2. The method of claim 1, wherein the employee activity data is received in one of:
real-time;
near real-time; and
a batch at an interval of at least one of:
one hour;
six hours;
twelve hours; and
one day.

3. The method of claim 1, wherein the activities or alerts are each associated with one of a plurality of pre-defined domains.

4. The method of claim 1, further comprising receiving historical employee data and generating the respective Markov model for each employee based on the historical data.

5. The method of claim 1, wherein the reinforcement learning model receives one or more employee attributes in addition to the one or more activities or alerts.

6. The method of claim 1, further comprising receiving historical employee data and training the reinforcement learning model.

7. The method of claim 6, wherein the reinforcement learning model uses agents running Q-learning algorithms.

8. The method of claim 7, wherein each agent performs feature selection in each of a plurality of domains to maximize a risk.

9. The method of claim 8, wherein directed exploration technique is used in the reinforcement learning.

10. The method of claim 9, wherein softmax exploration techniques are used in the reinforcement learning.

11. The method of claim 1, further comprising:
receiving an indication of a particular employee;
receiving an indication of a specific time window; and
displaying employee risk information for the particular employee over the specific time window.

12. A system for use in detecting insider threats comprising:
a processor for executing instructions; and
a memory storing instructions, which when executed configure the system to perform a method comprising:
receiving employee activity data comprising one or more activities or alerts each associated with a respective employee of a plurality of employees;
applying the one or more activities or alerts for an employee to a respective Markov model transition matrix to determine a next possible action of the employee;
applying the one or more activities or alerts for the employee to a reinforcement learning model to predict an employee risk that the employee may be an insider threat; and
adjusting threat mitigation controls comprising one or more of employee monitoring controls and employee access control based on at least one of the determined next possible action and the predicted employee risk.

13. The system of claim 12, wherein the employee activity data is received in one of:
real-time;
near-real-time; and
a batch at an interval of at least one of:
one hour;
six hours;
twelve hours; and
one day.

14. The system of claim 12, wherein the activities or alerts are each associated with one of a plurality of pre-defined domains.

15. The system of claim 12, wherein the method performed by the system further comprises receiving historical employee data and generating the respective Markov model for each employee based on the historical data.

16. The system of claim 12, wherein the reinforcement learning model receives one or more employee attributes in addition to the one or more activities or alerts.

17. The system of claim 12, further comprising receiving historical employee data and training the reinforcement learning model.

18. The system of claim 17, wherein the reinforcement learning model uses agents running Q-learning algorithms.

19. The system of claim 18, wherein each agent performs feature selection in each of a plurality of domains to maximize a risk.

20. A non-transitory computer readable medium storing instructions which when executed by a processor configure a system to perform a method claim 1.
